(19) United States
(12) Patent Application Publication
(10) Pub. No.: US 2014/0233343 A1
(43) Pub. Date: Aug. 21, 2014

(54) TOOLS FOR PRECISELY, CONSISTENTLY, AND RELIABLY PROPELLING A WIDE RANGE OF PARTICULATE MEDIA

(71) Applicant: Edward M. Reilley, Granada Hills, CA (US)

(72) Inventor: Edward M. Reilley, Granada Hills, CA (US)

(73) Assignee: COMCO, INC., Burbank, CA (US)

(21) Appl. No.: 13/772,624

(22) Filed: Feb. 21, 2013

(51) Int. Cl. B01F 15/02

(52) U.S. Cl. CPC B01F 15/0263; B01F 15/026
USPC 366/108; 366/151.1; 366/182.3; 366/182.2

(57) ABSTRACT

Novel systems and apparatuses for dispensing particulate media are disclosed. One such system may include a storage tank for storing media, a feed tube in communication with the tank, a mixing chamber in communication with the feed tube, a tank sensor to detect pressure within the storage tank, and a mixing chamber sensor to detect pressure within the mixing chamber, wherein the mixing chamber is preferably configured to receive media when the pressure within the storage tank is about equal to the pressure within the mixing chamber. A non-pressurizable vibrator is preferably mounted external to the feeder. The vibrator is configured to vibrate media received in the feed tube from the media tank substantially along the feed tube toward the mixing chamber. The media dispensing system may further comprise an accelerometer in communication the vibrator to provide feedback regarding vibration of the feed tube.

### BACKGROUND

The present disclosure relates generally to blasting technology and particularly media dispensing tools for cleaning, cutting, surface texturing, abrading, or peening at a highly detailed and even micron-size level.

Numerous techniques exist to propel particulate media at target parts. One technique may be referred to as an atmospheric Venturi feed in which an air hose puts an air stream through a two-part nozzle. A gap between the first and second nozzles creates a Venturi effect that pulls media into the air stream from a second hose. The mixture is then accelerated out a nozzle. This approach has a very narrow pressure and nozzle-size window that will create a Venturi. As a consequence, there is essentially no control over how much media is introduced. Nor is there much control over how fast the media exits the nozzle.

Another technique involves a gravity feed in which a stream of free flowing media is dropped into a fast moving air stream that has just emerged from a nozzle. There is a limit to how fast the media can get moving as the air is already slowing down by the time it meets the media. Gravity feed technology is typical in shot peening machines.

Another technique utilizes a centripetal wheel. Here, media is axially introduced to a spinning paddle wheel. The media is accelerated by the wheel and fired through a control window at a target part. This technique is typical in very large shot peen machines.

The most common particulate dispensing technique involves pressure pot Venturi feed technology. This technique is similar to atmospheric Venturi feed but the media is stored in pressurized tanks Doing so vastly broadens the workable pressure and nozzle range.

Another technique utilizes a vibratory shaker to dispense media. To elaborate, the technology typically uses two pressurized tanks, one located above another. The top tank holds powder. The lower tank is mounted on a vibrator. The bottom of the lower tank has an orifice plate installed with numerous small holes. The vibrator shakes the bottom tank as if it were an inverted salt shaker, causing media to feed through the holes. This technology is relatively complex in physical construction, as the orifice plate needs to be in a pressurized environment but also needs to be accessible to clear its clogs. This technology also feeds a relatively uncontrollable amount of powder, and a great deal of it.

Another technique involves a vibratory helix design. The vibratory helix technique consists of a cylindrical pressure vessel that contains a vibrated cup. The cup has a helix on its inside surface, and as the rotary vibrator moves rotationally and vertically, media that has filled the cup walks its way up the helix. As the interface between the cup and pressure vessel is not media-tight, media gets down into the rotary vibrator and binds the whole unit up. As a result, while this unit is consistent, it also unfortunately unreliable and complicated to repair.

Yet another technique involves magnetically metering shot into an air stream. Unfortunately, such a device only works with ferromagnetic shot.

A superior technique compared to those above involves pneumatic modulation, which is unique to the assignee of the present application, Comco Inc. With this technique, a pressurized tank of media has a hole in the bottom that opens to an air passageway. The air that passes through this passageway has its pressure rapidly fluctuated to fluidize media locally in the tank just above the hole. This media is then fed into the air stream.

Regardless of blast technology, there are three important variables in the blast stream as it leaves the nozzle on its way to hit a part: (1) media; (2) quantity; and (3) velocity. Consistency within each of these variables is key.

To elaborate with regard to media, the media being shot typically ranges from very fine aluminum oxide powder (5 micron nominal diameter) to grit and bead up to one-quarter of an inch in diameter. The size and type of media are selected based on the application at hand. Media consistency means making sure the material is all dimensionally and chemically identical. For example, a 50 micron glass bead (sphere) and a 400 micron aluminum oxide (block) will have very different effects on a target part.

Quantity refers to the amount of media being released from the nozzle on both a long-term and instantaneous basis. The typical industry range is between 1 gram per minute and 2000 pounds per minute, depending on the equipment and the task at hand. Consistency here is measured as flow rate per unit of time. For very large centripetal wheel machines, a “consistent” machine may put out 2000±200 lb/min. For small and very accurate microblasters, a “consistent” machine may put out 15±0.05 g/m of media. In all cases it is desirable to have the blaster put out as close to ±0 as possible. This tolerance yields the most consistent and predictable results on the target part.

Velocity refers to the speed of both individual particles as well as an average of the blast stream as a whole, after leaving the nozzle. Depending on machine and application, speeds range between 10 to 1000 miles per hour. Work done by the particles is largely based on kinetic energy. Since kinetic energy is a function of velocity squared, velocity is thus important. With the exception of the centripetal wheel, all known blast technologies control velocity using air pressure. The quantity of media in the air stream also plays a role as more media slows the air stream down. A very inconsistent flow quantity will also result in a very inconsistent velocity profile. Consistency is measured as deviation in velocity from a nominal amount, ideally ±0.

In general, a low quality blaster such as an atmospheric Venturi feed will have a very limited velocity range, limited nozzle size range, and will flow media at widely varying quantities and velocities. These issues make the nozzle look like it is spurting and coughing. The lack of adjustable range means this type of blaster has limited uses, but it is an inexpensive (and very widely used) technology.

In general, a high quality blaster will allow for a wide range of media, nozzles, powder output, and velocity. However, even high quality blasters have their downfalls when very fine powders are used. In particular, since very fine powders are cohesive, they are very difficult to flow consistently. As finer media are useful in industries such as medical and electronics where ever-shrinking target part sizes require smaller media sizes to get into tight areas or erode material with higher resolution (or create smoother surface finishes), the problem with fine powders must be solved.

Finally, conventional blasting technologies typically have some degree of coupling between the pressurized stream and media feed quantity. Consequently, typical blasting units are unable to feed any amount of media into any amount of pressurized air.

Accordingly, novel systems and apparatuses for precisely, consistently, and reliably propelling a wide range of particulate media are therefore desired.

### SUMMARY

One exemplary embodiment of the disclosed subject matter is a media dispensing system comprising a storage tank for storing media, a feed tube in communication with the tank, a mixing chamber in communication with the feed tube, a tank sensor to detect pressure within the storage tank, and a mixing chamber sensor to detect pressure within the mixing chamber. The mixing chamber is preferably configured to receive media when the pressure within the storage tank is about equal to the pressure within the mixing chamber. In particular, the mixing chamber is preferably configured to receive media via a valve assembly that opens to permit media to flow into the mixing chamber and closes to exclude media from entering the mixing chamber. The storage tank may have a conic bottom about which a media plug is disposed to aid in how the media exits the tank. A linear vibrator (can also be rotational) is preferably mounted external to the feeder. The vibrator is configured to vibrate media received in the feed tube from the media tank substantially along the feed tube toward the mixing chamber. The media dispensing system may further comprise an accelerometer in communication with the vibrator to provide feedback regarding vibration of the feed tube.

Another exemplary embodiment of the disclosed subject matter is an apparatus comprising a media feed tube, a vibrator configured to vibrate the feed tube, an accelerometer in communication with the vibrator, and a mixing chamber in communication with the feed tube. The vibrator may be mounted external to the feed tube and be non-pressurizable. The apparatus may further comprise a pressurizable storage tank in communication with the feed tube, wherein the mixing chamber is configured to receive media when pressure within the storage tank is about equal to the pressure within the mixing chamber.

A further exemplary embodiment of the disclosed subject matter is an apparatus comprising a media feed tube having a media entrance proximate a first end, a non-pressurized vibrator mounted external to the media feed tube to vibrate media received in the media entrance substantially along the tube toward a second end, and a mixing chamber disposed about the second end of the media feed tube, wherein the mixing chamber is configured to receive media from the media feed tube. The apparatus may further comprise an accelerometer in communication with the vibrator. The apparatus may also comprise a pressurizable storage tank in communication with the feed tube, wherein the mixing chamber is configured to receive media when pressure within the storage tank is about equal to the pressure within the mixing chamber.

Another exemplary embodiment of the disclosed subject matter is an apparatus comprising a media feed tube, a valve assembly in communication with the media feed tube, and a mixing chamber in communication with the media feed tube. The valve assembly preferably comprises a housing, a cup slideably disposed within the housing to open or close an aperture in the feed tube, and a ball flotably disposed to seat within a conic bottom of the mixing chamber. The apparatus may further include a pressurizable media storage tank for storing media. The cup and ball may be disposed to open the feed tube aperture when pressure within the media storage tank and mixing chamber are about equalized. The apparatus may also include a non-pressurized vibrator mounted external to the feed tube, and an accelerometer in communication with the vibrator to provide feedback regarding vibration of the feed tube.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a perspective view of a media dispensing system according to an embodiment of the inventions disclosed herein;

FIG. 2 is a perspective view of the media dispensing system illustrated in FIG. 1 with the cover panels and user interface removed to show internal details;

FIG. 3 is a perspective view of certain internal components of the media dispensing system illustrated in FIG. 1;

FIG. 4 is a perspective view of the media storage tank, vibrator, and feeder and mixing chamber assembly of the media dispensing system illustrated in FIG. 1;

FIG. 5 is a cut-away view of the components illustrated in FIG. 4;

FIG. 6 is a cut-away view of certain components illustrated in FIG. 4 showing the valve assembly in an open configuration;

FIG. 7 is a cut-away view of certain components illustrated in FIG. 4 showing the valve assembly in a closed configuration;

FIG. 8 is a cut-away view of certain components of a media dispensing system according to another embodiment of the inventions disclosed herein;

FIG. 9 is a cut-away view of certain components of a media dispensing system according to another embodiment of the inventions disclosed herein;

FIG. 10 is a cut-away view of certain components of a media dispensing system according to another embodiment of the inventions disclosed herein;

FIG. 11 is a cut-away view of certain components of a media dispensing system according to another embodiment of the inventions disclosed herein;

FIG. 12 is a cut-away view of certain components of a media dispensing system according to another embodiment of the inventions disclosed herein;

FIG. 13 is a cut-away view of certain components of a media dispensing system according to another embodiment of the inventions disclosed herein;

FIG. 14 is a cut-away view of certain components of a media dispensing system according to another embodiment of the inventions disclosed herein;

FIG. 15 is a perspective view of certain components of a media dispensing system according to another embodiment of the inventions disclosed herein;

FIG. 16 is a cut-away view of certain components of a media dispensing system according to another embodiment of the inventions disclosed herein;

FIG. 17 is a cut-away view of certain components of a media dispensing system according to another embodiment of the inventions disclosed herein;

FIG. 18 is a cut-away view of certain components of a media dispensing system according to another embodiment of the inventions disclosed herein;

FIG. 19 is a cut-away view of certain components of a media dispensing system according to another embodiment of the inventions disclosed herein;

FIG. 20 is a cut-away view of certain components of a media dispensing system according to another embodiment of the inventions disclosed herein; and

FIG. 21 is a cut-away view of certain components of a media dispensing system according to another embodiment of the inventions disclosed herein.

### DETAILED DESCRIPTION

A general problem in the field of media dispensing systems is the inability to dispense very fine powders consistently as such powders are typically cohesive. A general solution is actively feeding the media into a pressurized stream.

A technical problem in the field of media dispensing systems is reliably feeding particulate media into a pressurized stream to be propelled at a target. A technical solution implementing the spirit of the disclosed inventions is the use of a non-pressurized vibrator mounted external to a feed and mixing chamber assembly.

Potential benefits of the general and technical solutions provided by the disclosed subject matter include those identified above plus more accurately metering particulate media into a pressurized gas stream than any other known technology. The disclosed inventions also advantageously work with a broader range of compatible media sizes to solve a variety of problems with fewer pieces of equipment. Moreover, unlike conventional blasting technologies that have some degree of coupling between the pressurized stream and media feed quantity, the disclosed inventions also advantageously actively feed any amount of media into any amount of pressurized air.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

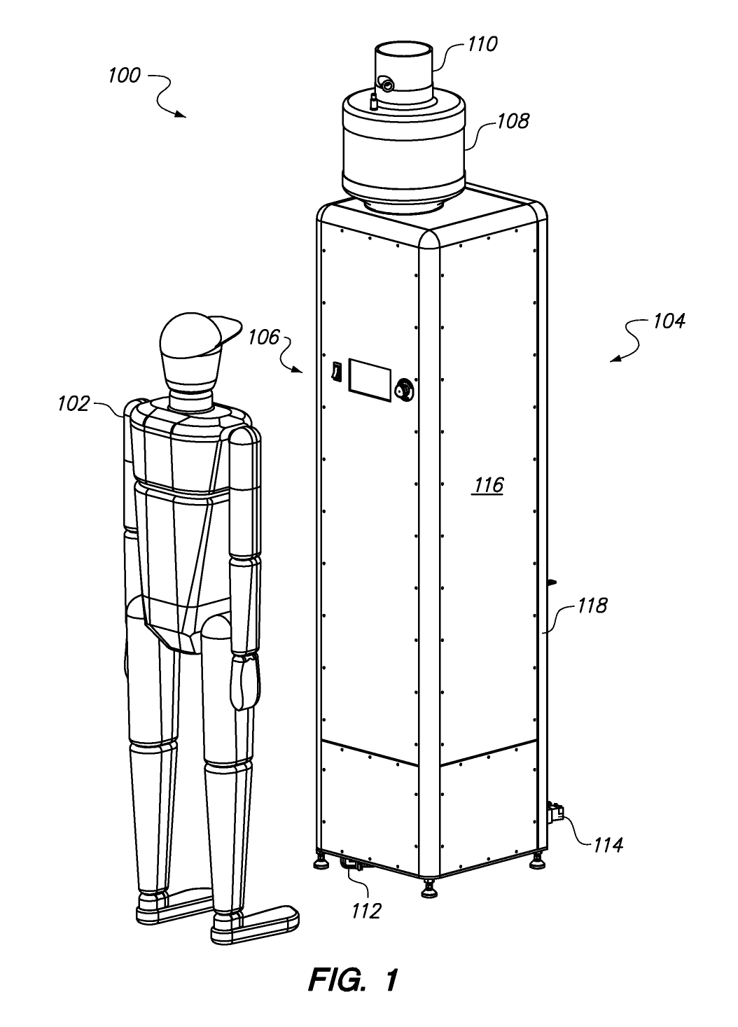

FIG. 1 is a perspective view of a media dispensing system according to an embodiment of the inventions disclosed herein. Turning in detail to FIG. 1, a media dispensing system 100 may be seen with a user 102 standing proximate the user interface 106 of the system 100. The dispensing system 100 may include a housing 104 having cover panels 116 and a frame 118. An unpressurized media storage hopper 108 is mounted external the housing 104. The storage hopper 108 is in communication with a media receiver 110 for receiving media from a larger media holding tank (not shown). The media may be abrasive or non-abrasive particulate materials including but not limited to (1) typically highly pure, micron-size fine powders (usually 10 to 150 microns) formed from such materials as crushed glass, silicone carbide, and aluminum oxide; (2) micron-size shot peening material (typically 150 microns or finer) such as glass bead or zirconia media; or (3) standard-sized shot peening material (typically 0.007 in to 0.060 in) such as cast or wrought steel, stainless steel, glass bead, or zirconia; or (4) any combination of the above. Advantageously, the dispensing systems and apparatuses disclosed herein have no theoretical upper limit concerning the size of the media to be dispensed.

The dispensing system 100 also includes a working fluid inlet 112 for pressuring the unit 100. The working fluid is preferably clean, dry air. The dispensing system 100 further includes an air and media exit and splitter (splitter is optional) or discharge port 114 at or about the bottom of the system 100 (this system 100 allows the exit to come out any face, to further enhance the mountability of the unit). The inlet 112 is preferably disposed at the bottom of the housing 104 to permit the system 100 to be mounted flush to another piece of equipment.

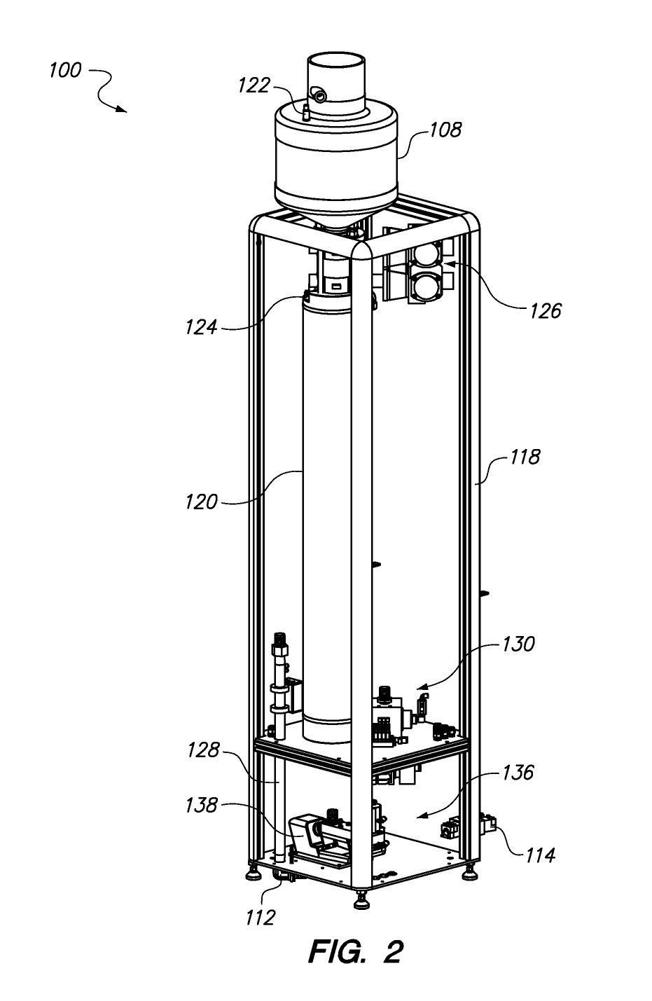

FIG. 2 shows the example system 100 illustrated in FIG. 1 without cover panels 116 and user interface 106. As seen in FIG. 2, the system 100 includes framing members 118 that contain a media storage tank 120 and other components. The tank 120 is in communication with the media storage hopper 108 at one end and a feeder and mixing chamber assembly 136 at the other end. The media storage tank is pressurizable by way of pressurized air coming from inlet 112. This air may go through an optional air flow meter pipe 128 connected to an optional pressure regulator 130 via a hose (not shown) and a manifold 132 to control various air cylinders and purges. The flow meter 128 is preferably Model No. CDI-5200 sold by CDI Meters. The pressure regulator 130 is preferably electronic but may be manually operated.

Valve 126 is located between the bottom of the media storage hopper 108 and the top of media storage tank 120. The top portion of valve 126 is configured to stop media from entering the tank 120 and protects the bottom portion of valve 126. The bottom portion of butterfly valve 126 is configured to seal the pressurized tank 120.

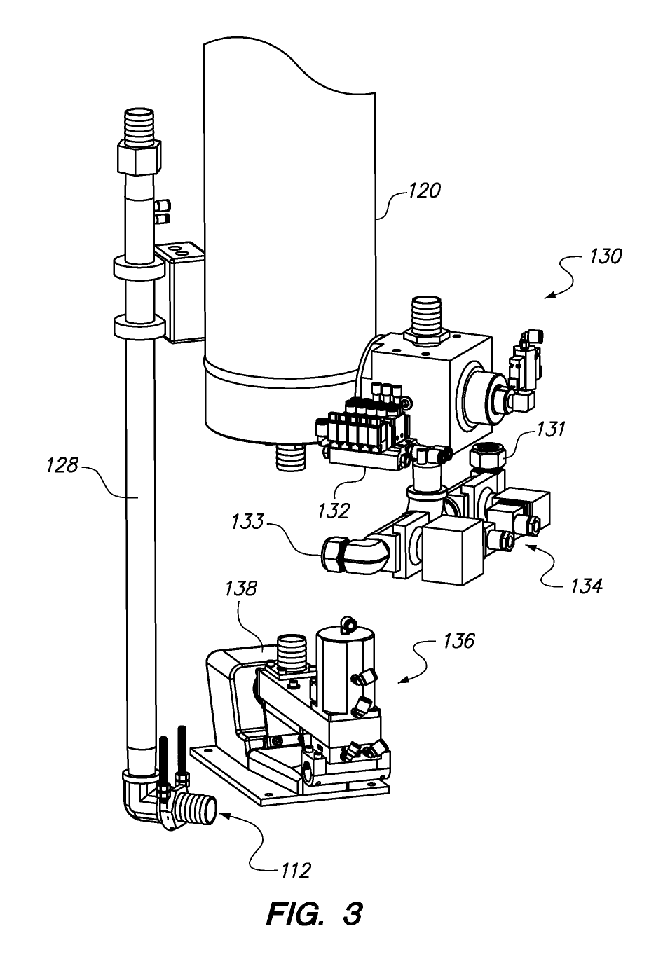

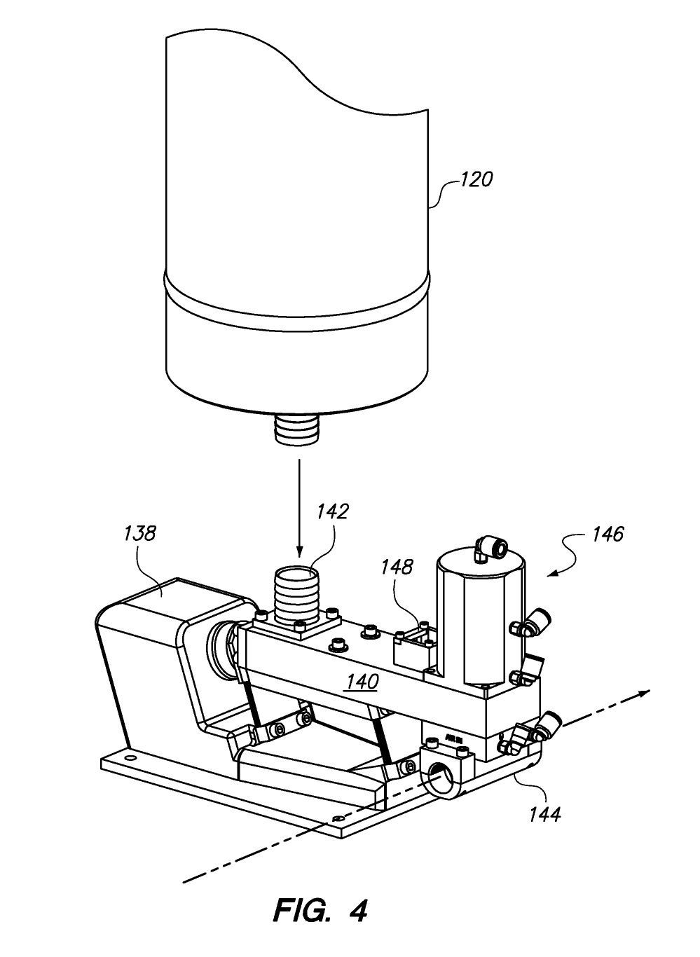

Turning in detail to FIGS. 3 to 5, the regulator 130 is also preferably in communication with blast valves 134, which are in communication with an outlet 131 for connecting to the top of tank 120, and an outlet 133 for connecting to the feeder and mixing assembly 136. The connection from outlet 133 to assembly 136 is made via a hose (not shown). A hose (not shown) connects tank connector 150 to a feed tube connector 142 disposed about the top of a feed tube 140 that comprises part of the feeder and mixing assembly 136.

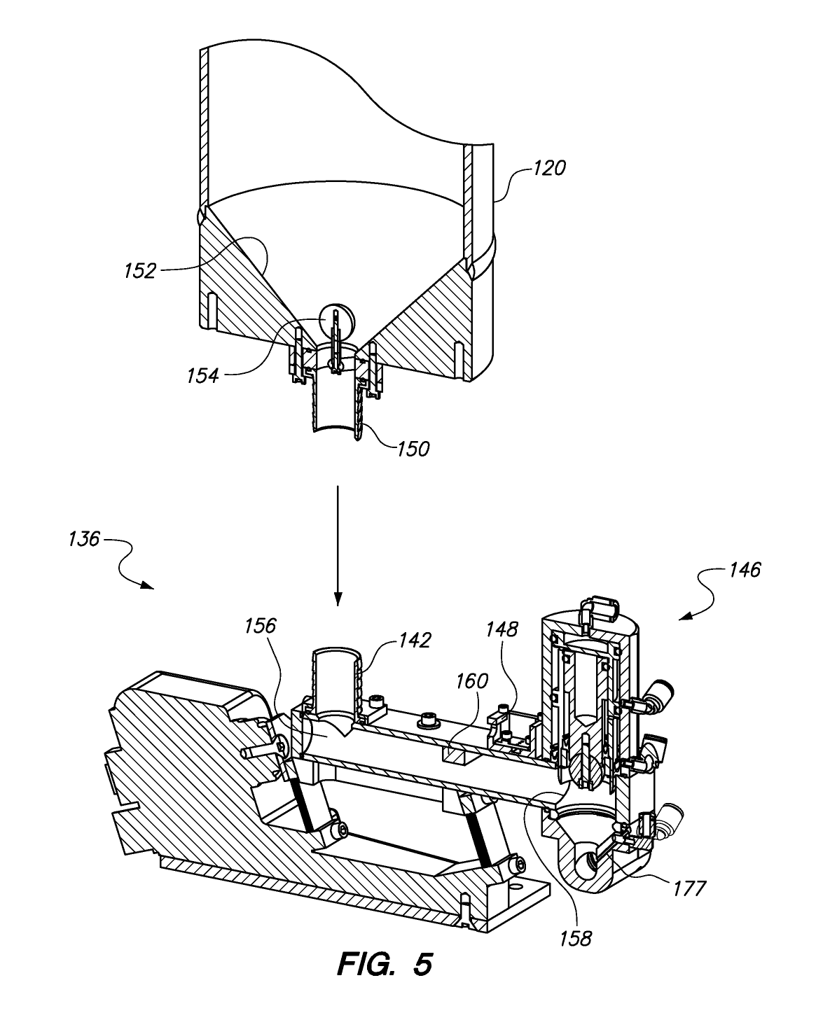

The feed tube 140 has a first end that includes a feed tube media entrance or port 156 for receiving media from the tank 120. The feed tube 140 also has an opposing second end with a feed tube discharge port or aperture 158 for discharging media out the feed tube 140 and into the mixing chamber 144. The feed tube 140 is shown with circular geometry in FIG. 5; however, triangular or diamond geometry is preferred with optional dam 160. The dam 160 is configured to rake the media flat or otherwise level off the media as it passes substantially along the length of the feeder tube 140 before it enters the mixing chamber 144. Doing so gives a constant cross-section of media that can be fed at varying velocities by adjusting the intensity of vibrator 138.

FIG. 5 also shows that the media storage tank 120 may have a conic bottom 152 and an associated media plug 154 disposed about the bottom 152. The plug 154 advantageously helps control the weight of the media such that it does not overload the feed tube 140 and in turn the vibrator 138.

As best seen in FIGS. 5 to 7, the feed tube 140 is in communication with a valve assembly 146 at or about the end of the tube 140 opposite the feed tube media entrance 156. The valve assembly 146 may comprise a media resistant valve sold by the assignee of the present application, Comco Inc., under the federally registered trademark PowderGate® or other valve. The valve assembly 146 preferably comprises a housing 162, a cup 164 slideably disposed within the housing 162 to open or close the feed tube discharge aperture 158 in the feed tube 140 by engaging a seal 186, and a ball 166 flotably disposed (ball 166 rides piston 165, both of which are then slideably disposed) to open or seal the conic entry 178 into the mixing chamber 144. The mixing chamber 144 has an aperture 180 for passing media to be mixed with a pressurized fluid to be propelled at a target.

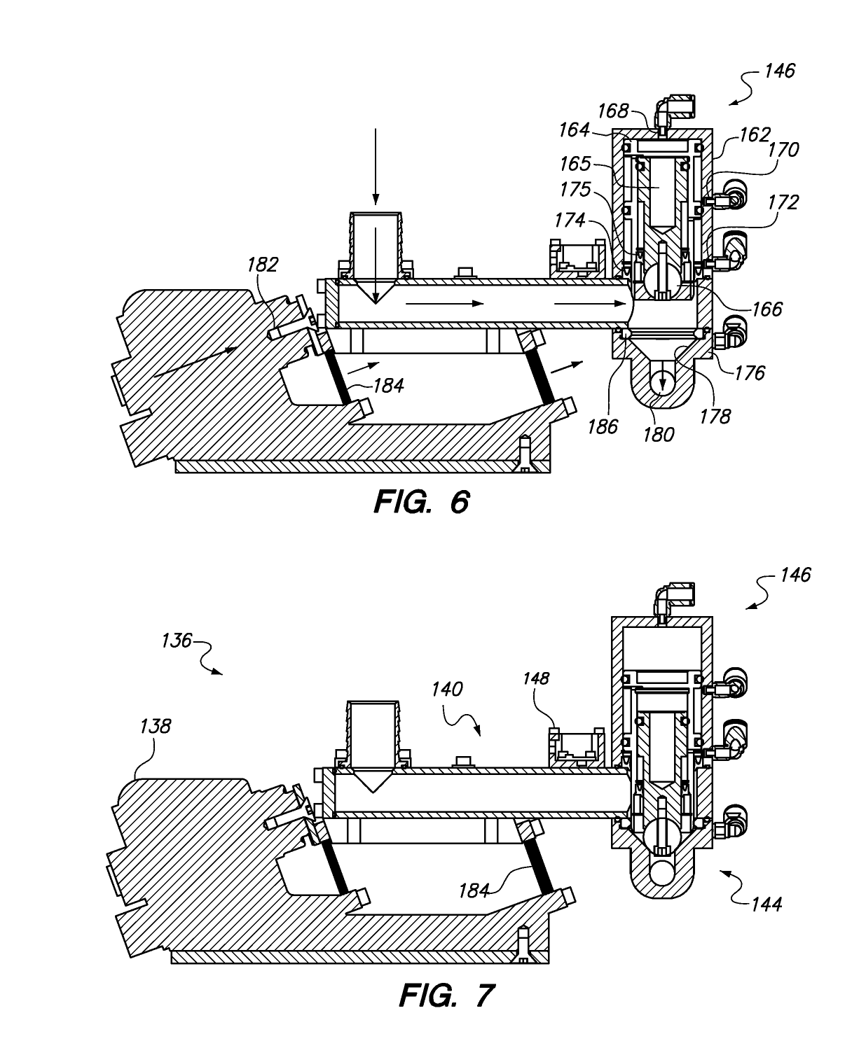

FIG. 6 shows the valve assembly 146 open, namely, both the cup 164 and ball 166 are in their full open and most upwards location. This arrangement allows a flow path through the feed tube 140, out discharge port 158 through a seal 186, into mixing chamber 144, past conic bottom 178, and into mixing chamber discharge port 180. The cup 164 and ball 166 are simply out of the way in this case. FIG. 7 shows the valve assembly 146 closed. After the vibrator 138 is turned off, the cup 164 is brought down and slides past the seal 186. This wiping action blocks the media path out of the feed tube 140. Then purge air is activated via a pneumatic fitting shown nearest mixing chamber purge port 176. This purge air blows any residual media that may be under the cup 164 out from the conic area 178 so ball 166 can subsequently descend and create an air-tight seal against mixing chamber conic bottom 178.

FIG. 6 also illustrates that the preferred vibrator 138 includes a magnet 182 and one or more leaf springs 184, such as the linear vibrators of FMC Technologies and particularly Sintron® industrial vibrators Model Numbers F-T0 and F-T01. In operation, the magnet 182 pulls the feed tube 140 back and down; the tube 140 is then let go. The leaf springs 184 then take the feed tube 140 forward and up. This action repeats at high frequency to cause media in the feed tube 140 to move left-to-right as shown in FIG. 6. The frequency and intensity of action is controlled by electronics (not shown).

The media dispensing system 100 also preferably includes a 3-axis accelerometer 148 disposed on top of the feeder tube 140. The accelerator 148 is in communication with the driver electronics (not shown) to provide feedback regarding intensity of vibrator 138. The accelerometer 148 is preferably Model No. ADXL325 sold by Analog Devices.

The valve assembly also includes a cup control port 168, a piston control port 170, a mixing chamber control port 172, seal ring 174, a mixing chamber purge port 176, and another seal ring 175 against the piston 165. The mixing chamber control port 172 is preferably pressurized at higher pressure than the media to keep media out of the moving parts and to retract the cup 164 and piston 165. The mixing chamber 144 also includes a mixing chamber pressure tap 177 in communication with a remote sensor (not shown), wherein the mixing chamber 144 is configured to receive media when pressure within the storage tank 120 is about equal to the pressure within chamber 144.

The overall typical operation of media dispensing system 100 is described as follows. Air enters the system 100 from underneath housing 104 via inlet 112. This air enters through optional air flow meter pipe 128 that takes real-time readings of the mass flow of air. A pressure tap (not shown) may be taken off the same pipe 128 and sent to a pressure sensor to ensure the blaster unit 100 properly responds to under and over-pressure supply situations. A second air tap (not shown) may take off some air to operate the control valve manifold 132.

Air from the inlet pipe 128 is routed to the electronic pressure regulator 130. A circuit board (not shown) uses pressure feedback from the tank pressure sensor 124 and/or blast pressure sensor to set output pressure according to the desired setting. For example, if the desired setting is 100 psi, then the regulator 130 will internally regulate to 100 psi when the blaster unit 100 is sitting closed, but when blasting the pressure reading is taken from the mixing chamber 144 and pressure will be increased to compensate for frictional losses due to flow.

After passing through the regulator 130, the air preferably goes through a tee and encounters two valves 134. One valve is normally open (“NO valve”) and allows air to fill the top of the tank through fitting 131. The other valve is normally closed (“NC valve”) and is coupled to the mixing chamber 144 through fitting 133. When the blaster unit 100 is first powered, the tank 120 will pressurize to the pressure set via the NO valve. When the blaster 100 is commanded to blast, the NO valve will close and the NC valve will open. This action will direct air from the regulator 130 through the mixing chamber 144 and out to the nozzle(s) (not shown) aimed at a target (not shown) such as a bone screw.

The feeder and mixing chamber assembly 136 sits underneath the tank 120 and is coupled by a flexible hose (not shown). The inside of the tank 120, hose, and feeder and mixing chamber assembly 136 are kept pressurized whenever the machine 100 is on. Gravity drops media down into the feeder and mixing chamber assembly around a ball plug 154 and through the hose. To move the media substantially along the length of the feed tube 140 and out the end of the feed tube 140 in a “waterfall fashion,” the vibrator 138 is then actuated. In other words, the media is fed forward off the edge of tube 140 through aperture 158 where it falls into an air stream moving through mixing chamber discharge port 180. This falling action means that the media does not gain any meaningful velocity until it is within the tubing (not shown) on the way to the nozzle, advantageously minimizing wear in the feed assembly 136.

The amount of media, including a positive zero, can be controlled by the feeder and mixing chamber assembly 136. In particular, the accelerometer 148 on the feeder and mixing chamber assembly 136 may constantly feed back intensity data to the control circuit (not shown). When more flow is desired, the circuit increases the vibrator 138 intensity until the target acceleration is met. Less flow is achieved by reducing the intensity. Should positively no flow be desired, one or both of the valves within valve assembly 146 can be closed so the passing air stream does not accidentally knock media off the edge of the waterfall. This method is useful on target parts that have regions to be blasted and not blasted, or if it is desired to use the blaster 100 as a blow-off gun.

As mentioned, a blast is started by turning the NO valve to closed and the NC valve to opened. The air flow through the mixing chamber 144 is monitored by a remote pressure sensor (not shown) in communication with mixing chamber tap 177. When the pressure in the mixing chamber 144 is substantially equal to the pressure in the tank 120, both valves within the valve assembly 146 are opened simultaneously, followed by the linear vibrator 138 being turned on. Media is then fed into the air stream for the time commanded.

When the unit 100 is commanded to stop, the linear vibrator 138 is turned off. The valve assembly cup 164 is then closed. This closing is a not-air-tight wiper valve designed to keep the valve assembly ball 166 clean enough to seal air tight. The cup 164 wipes past a seal 186 and blocks media from falling into the mixing chamber conic bottom 178 and discharge port 180. Purge air is then introduced into the mixing chamber conic bottom 178 to blow out any residual powder. Next, the ball 166 closes against its conic seat 178 to create an air-tight feeder seal. Finally, the NO and NC valves are returned to their NO and NC states.

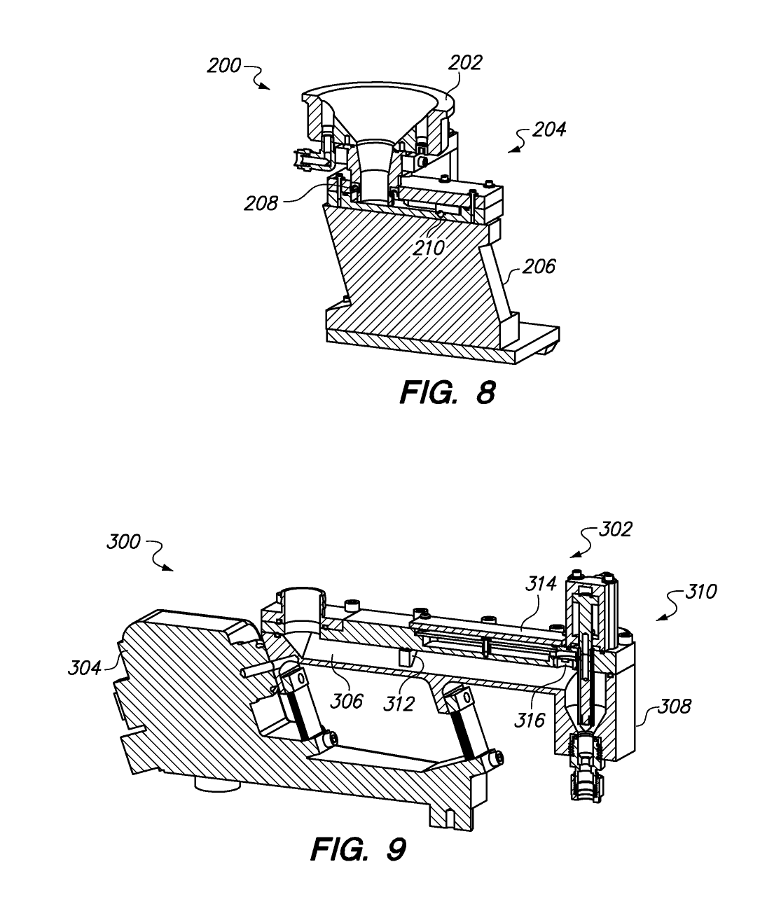

FIG. 8 is a cut-away view of certain components of a media dispensing system according to another embodiment of the inventions disclosed herein. Turning in detail to FIG. 8, a media dispensing system 200 comprises a media storage tank 202, a feeder and mixing chamber assembly 204, and a vibrator 206. A flexible seal 208 is disposed between the stationary tank 202 and moving feeder 204. In operation, media is stored in stationary hopper 202 and dropped into a linear vibrator tray below. The media is then conveyed along the length of the tray until it drops into a groove or slot 210 that has air flow within. This mixture is then taken out to a nozzle (not shown).

FIG. 9 is a cut-away view of certain components of a media dispensing system according to another embodiment of the inventions disclosed herein. Turning in detail to FIG. 9, a media dispensing system 300 comprises a media storage tank (not shown), a feeder and mixing chamber assembly 302 and a vibrator 304. The feeder and mixing chamber assembly 302 comprises a feed tube 306 in communication with a mixing chamber 308 and valve assembly 310. A dam 312 is optionally disposed within the feed tube 306 for raking the media level as it moves substantially along the length of the tube 306 as discussed above in the context of FIG. 5. Media dispensing system 300 may further comprise an accelerometer 314. As with media dispensing system 100, data from the accelerometer 314 of system 300 is fed back into control electronics (not shown) that drive the vibrator 304. Thus if a user puts the blaster unit 300 on a carpeted surface (which will dampen the vibrations), the accelerometer 314 will sense this dampening and the electronics will turn up the intensity. Blaster unit 300 may further comprise an integrated pressure sensor 316 in the mixing chamber 308. The sensor 316 provides input data pertinent to trying to keep the mixing chamber 308 at or about the same pressure as the tank to eliminate pneumatic flow. Absent equal pressure, air stored in the top of a dead-ended tank above the media may disadvantageously try to come out by going through the media and thereby push too much of it along the way.

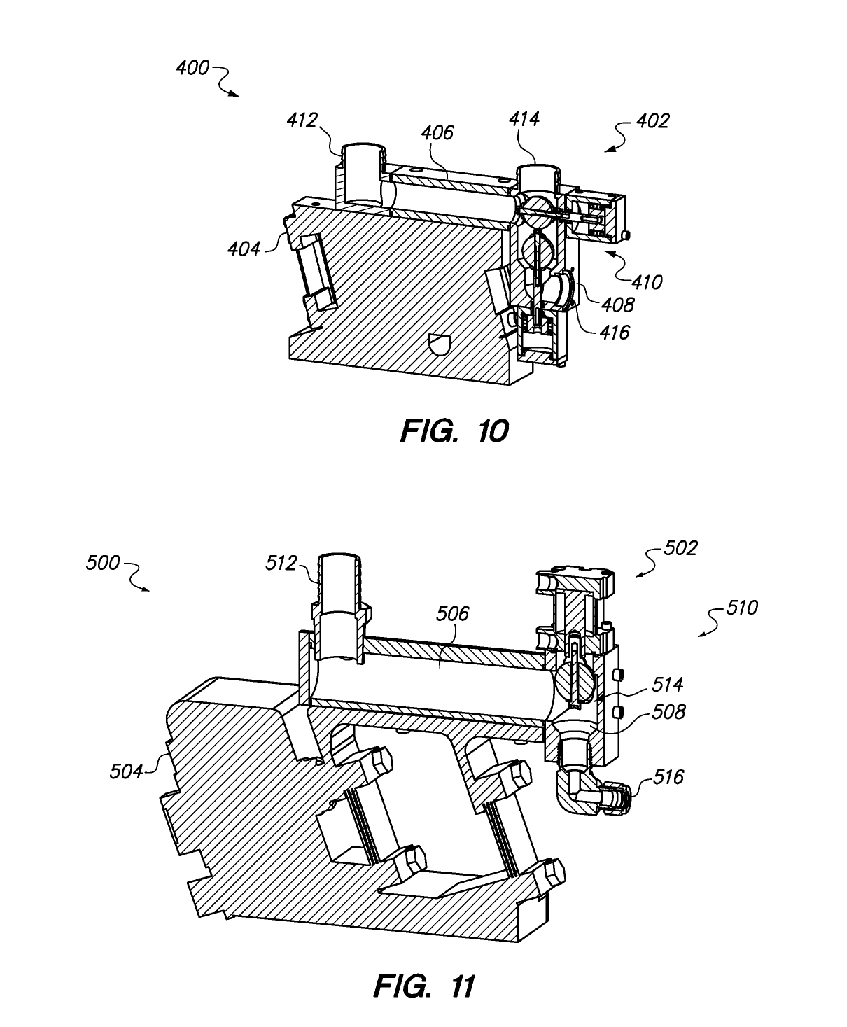

FIG. 10 is a cut-away view of certain components of a media dispensing system according to another embodiment of the inventions disclosed herein. Turning in detail to FIG. 10, a media dispensing system 400 comprises a media storage tank (not shown), a feeder and mixing chamber assembly 402, and a vibrator 404. The feeder and mixing chamber assembly 402 comprises a feed tube 406 in communication with a mixing chamber 408 and valve assembly 410. In operation, media from the storage tank will pass through media entrance 412, vibrate lengthwise along tube 406 until it falls out and meets pressurized air coming from blast air entrance 414. The media and air mixture then passes through a media and air exit 416 to be taken out to a nozzle (not shown).

FIG. 11 is a cut-away view of certain components of a media dispensing system according to another embodiment of the inventions disclosed herein. Turning in detail to FIG. 11, a media dispensing system 500 comprises a media storage tank (not shown), a feeder and mixing chamber assembly 502 and a vibrator 504. The feeder and mixing chamber assembly 502 comprises a feed tube 506 in communication with a mixing chamber 508 and valve assembly 510. In operation, media from the storage tank will pass through media entrance 512, vibrate lengthwise along tube 506 until it falls out and meets pressurized air coming from blast air entrance 514 that passes air in from the sides of the top of valve assembly 510. The media and air mixture then passes through a media and air exit 516 to be taken out to a nozzle (not shown).

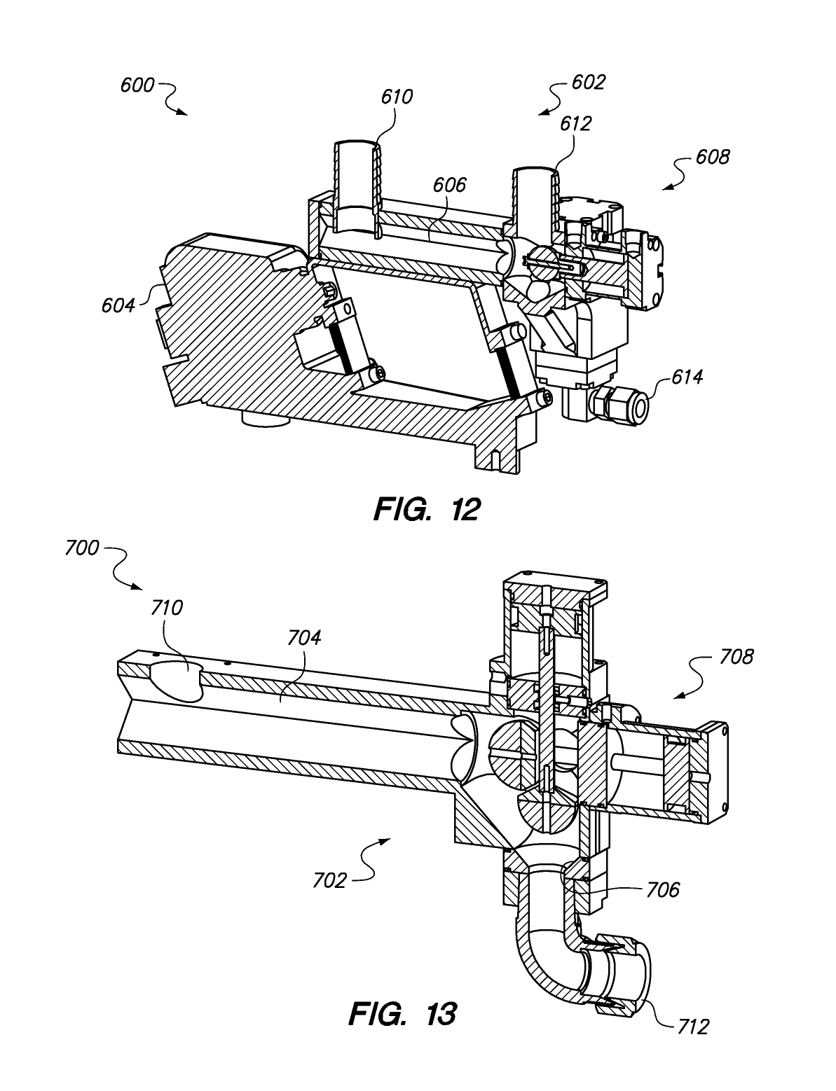

FIG. 12 is a cut-away view of certain components of a media dispensing system according to another embodiment of the inventions disclosed herein. Turning in detail to FIG. 12, a media dispensing system 600 comprises a media storage tank (not shown), a feeder and mixing chamber assembly 602, and a vibrator 604. The feeder and mixing chamber assembly 602 comprises a feed tube 606 in communication with a mixing chamber (not shown) and valve assembly 608. The valve assembly 608 is shown as including dual offset valves. In operation, media from the storage tank will pass through media entrance 610, vibrate lengthwise along tube 606 until it falls out and meets pressurized air coming from blast air entrance 612. The media and air mixture then passes through a media and air exit 614 to be taken out to a nozzle (not shown).

FIG. 13 is a cut-away view of certain components of a media dispensing system according to another embodiment of the inventions disclosed herein. Turning in detail to FIG. 13, a media dispensing system 700 comprises a media storage tank (not shown), a feeder and mixing chamber assembly 702 and a vibrator (not shown). The feeder and mixing chamber assembly 702 comprises a feed tube 704 in communication with a mixing chamber 706 and valve assembly 708. The valve assembly 708 is shown as including dual, heavy-duty valves interlaced to maintain vibrator balance. In operation, media from the storage tank will pass through media entrance 710 and vibrate lengthwise along tube 704 until it falls out and meets pressurized air. The media and air mixture then passes through a media and air exit 712 to be taken out to a nozzle (not shown).

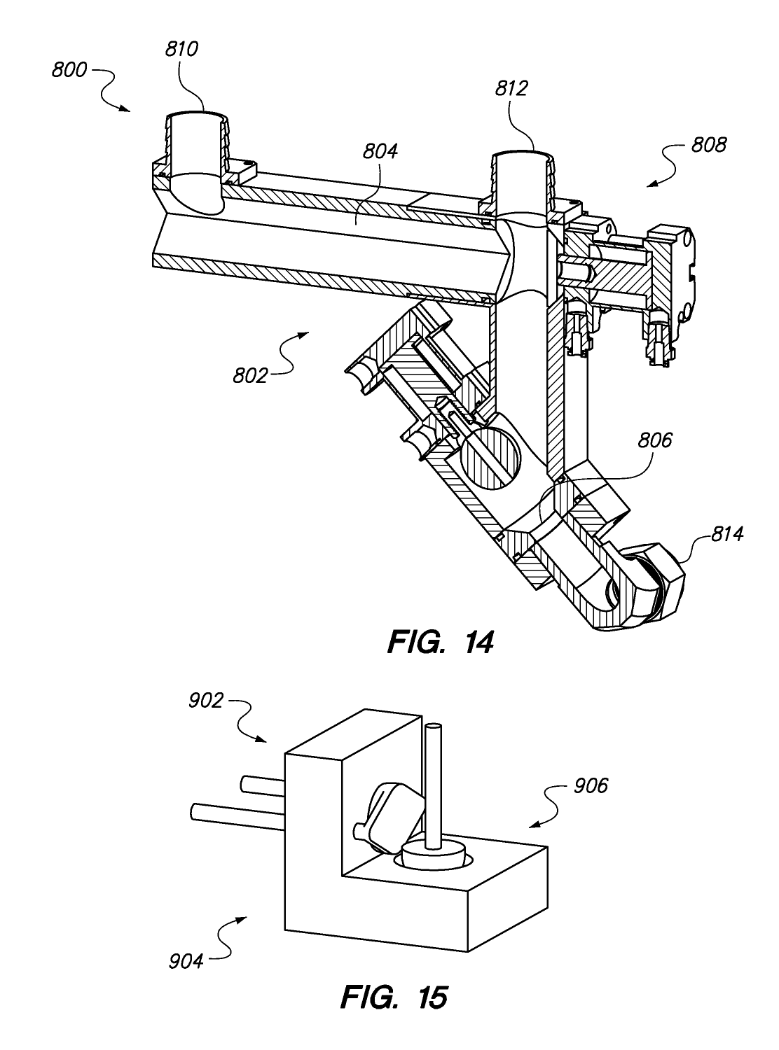

FIG. 14 is a cut-away view of certain components of a media dispensing system according to another embodiment of the inventions disclosed herein. Turning in detail to FIG. 14, a media dispensing system 800 comprises a media storage tank (not shown), a feeder and mixing chamber assembly 802 and a vibrator (not shown). The feeder and mixing chamber assembly 802 comprises a feed tube 804 in communication with a mixing chamber 806 and valve assembly 808. The valve assembly 808 is shown as including vertically offset valves. In operation, media from the storage tank will pass through media entrance 810, vibrate lengthwise along tube 804 until it falls out and meets pressurized air coming from blast air entrance 812. The media and air mixture then passes through a media and air exit 814 to be taken out to a nozzle (not shown).

FIG. 15 is a perspective view of certain components of a media dispensing system according to another embodiment of the inventions disclosed herein. FIG. 15 particularly shows a valve assembly 902 comprising two valves. One valve 904 is a media valve actuated by pulling to avoid interface with the other air valve 906.

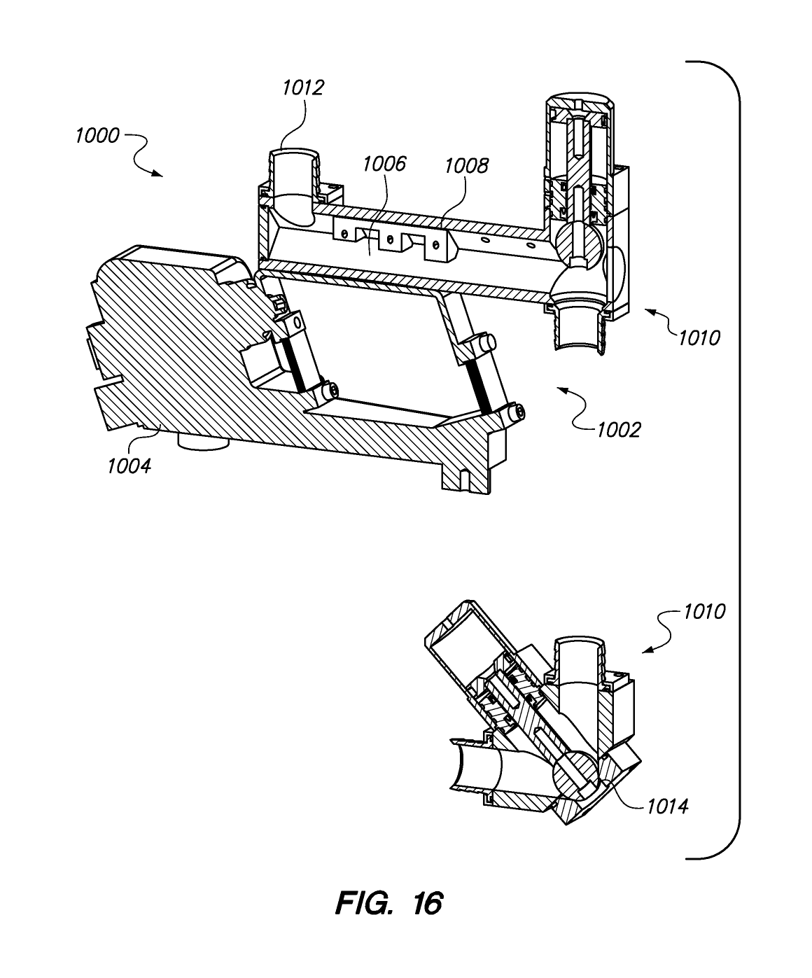

FIG. 16 is a cut-away view of certain components of a media dispensing system according to another embodiment of the inventions disclosed herein. Turning in detail to FIG. 16, a media dispensing system 1000 comprises a media storage tank (not shown), a feeder and mixing chamber assembly 1002 and a vibrator 1004. The feeder and mixing chamber assembly 1002 comprises a feed tube 1006 in communication with a mixing chamber 1014 and valve assembly 1010. The valve assembly 1010 is shown as including dual valves separated so only one rides the vibrator 1004. In operation, media from the storage tank will pass through media entrance 1012, vibrate lengthwise along tube 1006 and raked by optional dams 1008, until it falls out and through a flexible hose (not shown) to permit the media to meet pressurized air within the mixing chamber 1014. The media and air mixture then passes through a media and air exit (not shown) to be taken out to a nozzle (not shown).

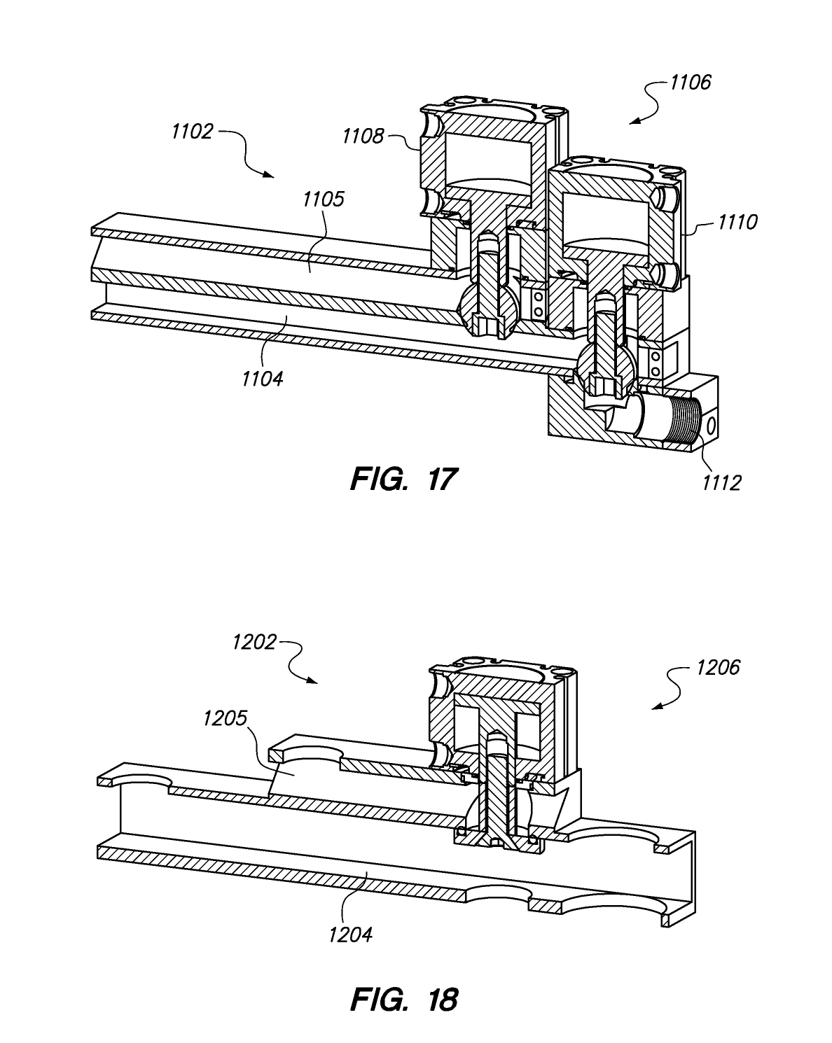

FIG. 17 is a cut-away view of certain components of a media dispensing system according to another embodiment of the inventions disclosed herein. FIG. 17 particularly shows a feeder and mixing chamber assembly 1102. The assembly 1102 may comprise a feed tube 1105, an air input tube 1104, and valve assembly 1106 configured to have a ceiling design with push-to-close valves 1108, 1110. In operation, media from the storage tank (not shown) will pass through the feed tube, vibrate lengthwise along tube until it falls out and meets pressurized air coming from air tube 1104. The media and air mixture then passes through a media and air exit 1112 to be taken out to a nozzle (not shown).

FIG. 18 is a cut-away view of certain components of a media dispensing system according to another embodiment of the inventions disclosed herein. FIG. 18 particularly shows a feeder and mixing chamber assembly 1202. The assembly 1202 may comprise a feed tube 1205, an air input tube 1204, and valve assembly 1206 configured to permit media to fall through the ceiling. The media falls into an air stream passageway 1204 and the mixture then continues out the second bottom hole (not indicated).

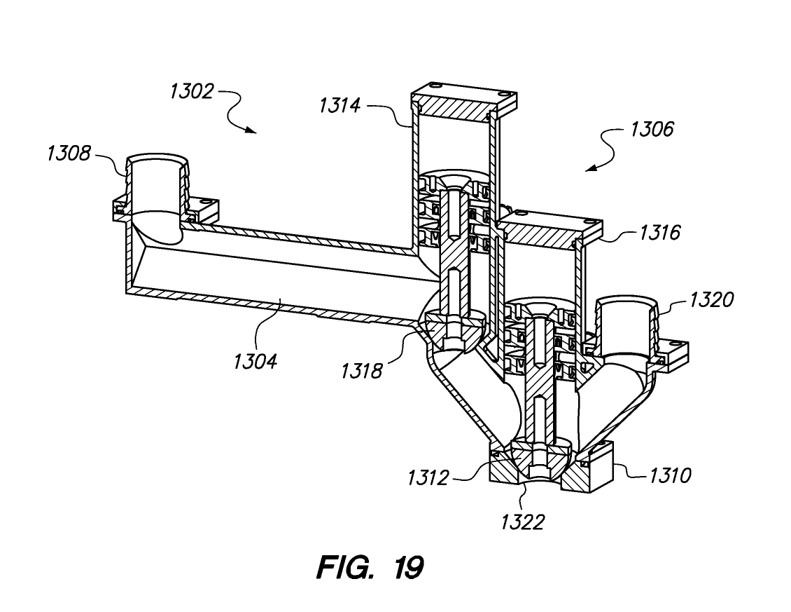

FIG. 19 is a cut-away view of certain components of a media dispensing system according to another embodiment of the inventions disclosed herein. FIG. 19 particularly shows a feeder and mixing chamber assembly 1302. The assembly 1302 may comprise a feed tube 1304 and valve assembly 1306 having offset valves 1314, 1316. Valve 1314 includes a ball 1318 for controlling the flow of media from entering mixing chamber 1310. Valve 1316 includes a ball 1312 to help control air flow coming through air tube connector 1320. Mixing chamber 1310 has a conic bottom 1312 and mixing chamber discharge port 1322. This port 1322 is configured to receive ball 1312. In operation, media from the storage tank (not shown) will pass through the feed tube connector 1308, into feed tube 1304, vibrate lengthwise along tube 1304 until it falls out and meets pressurized air coming through connector 1320. The media and air mixture then passes through mixing chamber discharge port 1322 to be taken out to a nozzle (not shown).

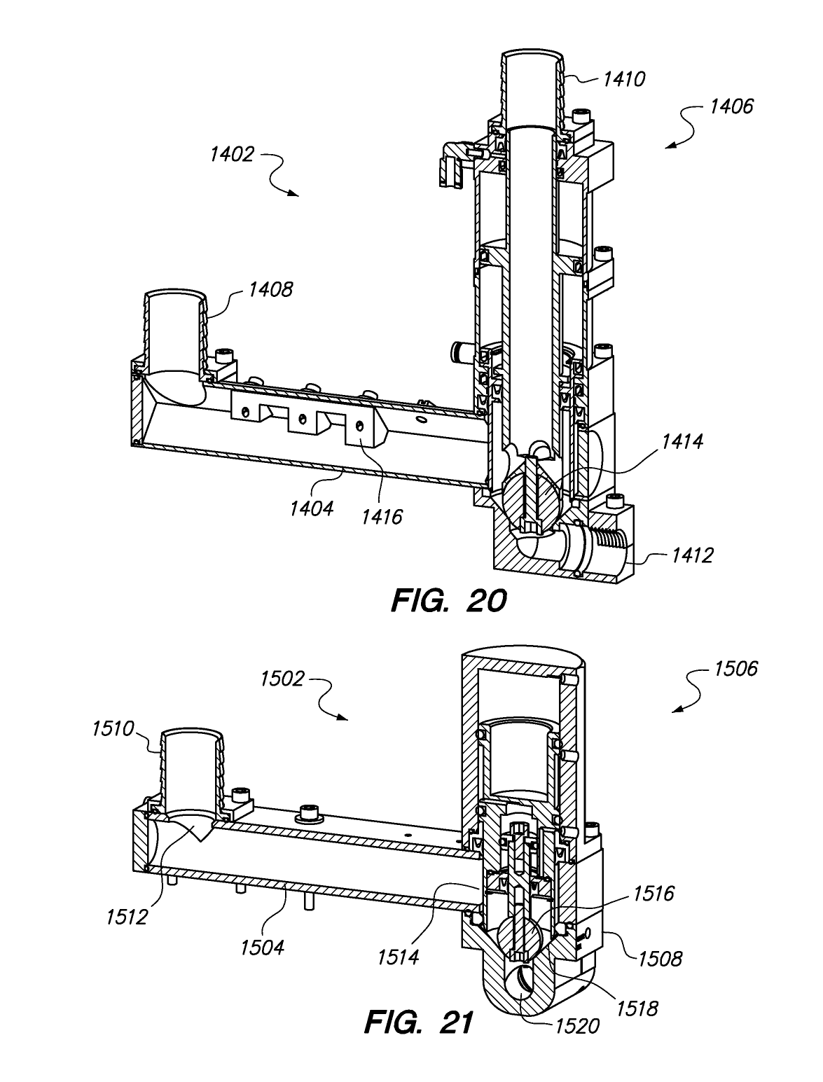

FIG. 20 is a cut-away view of certain components of a media dispensing system according to another embodiment of the inventions disclosed herein. FIG. 20 particularly shows a feeder and mixing chamber assembly 1402. The assembly 1402 comprises a feed tube 1404 and valve assembly 1406 having coaxial, dual valves with coaxial blast air. Valve assembly includes a ball 1414 that seats within a conic bottom of the mixing chamber (not indicated). In operation, media from the storage tank (not shown) will pass through feed tube connector 1408, into feed tube 1404, vibrate lengthwise along tube 1404 and raked by optional dams 1416, until it falls out to meet pressurized air coming through air tube connector 1410, which is in communication with the mixing chamber. The media and air mixture then passes through a media and air exit 1412 to be taken out to a nozzle (not shown).

FIG. 21 is a cut-away view of certain components of a media dispensing system according to another embodiment of the inventions disclosed herein. FIG. 21 particularly shows a feeder and mixing chamber assembly 1502. The assembly 1502 may comprise a feed tube 1504 and valve assembly 1506 having a cup (not indicated) and ball 1516 arrangement. The feed tube 1504 and valve assembly 1506 are in communication with mixing chamber 1508 having a conic bottom 1518 and discharge port 1520, wherein the conic bottom 1518 is configured to receive ball 1516. In this embodiment and similar to embodiment 100, rather than controlling both the media and pressurized air pathways via a valve assembly, only the media path is blocked with the valve assembly 1506. An external valve (not shown) is used to stop the main air flow. A pressure tap (not shown) in the mixing chamber 1508 is connected via a hose between this tap and an external pressure sensor. Moreover, similar to embodiment 100, a pressure sensor (not shown) is used to watch the pressure of the media storage (not shown). In operation, when a blast is initiated, the blast air valve is opened while watching the two pressure sensors. When the two sensors are about equal, the valves within valve assembly 1506 are opened to start the flow of media. In particular, media from the storage tank (not shown) will pass through feed tube connector 1510, into feed tube 1504, and vibrate lengthwise along tube 1504 until it falls out feed tube discharge port 1514 to meet pressurized air entering into mixing chamber 1508. The media and air mixture then passes through a media and air exit (not shown) to be taken out to a nozzle (not shown).

While certain embodiments have been described, the embodiments have been presented by way of example only and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. An apparatus comprising:
a media feed tube;
a vibrator configured to vibrate the feed tube;
an accelerometer in communication with the vibrator; and
a mixing chamber in communication with the feed tube.

2. The apparatus of claim 1, wherein the vibrator is mounted external to the feed tube.

3. The apparatus of claim 1, further comprising a pressurizable storage tank in communication with the feed tube, wherein the mixing chamber is configured to receive media when pressure within the storage tank is about equal to the pressure within the mixing chamber.

4. The apparatus of claim 1, wherein the feed tube is configured to be pressurized, wherein the mixing chamber is configured to be pressurized, and wherein the vibrator is not configured to be pressurized.

5. An apparatus comprising:
a media feed tube having a first end, an opposing second end, and a media entrance proximate the first end;
a non-pressurized vibrator mounted external to the media feed tube to vibrate media received in the media entrance substantially along the tube toward the second end; and
a mixing chamber disposed about the second end of the media feed tube, wherein the mixing chamber is configured to receive media from the media feed tube.

6. The apparatus of claim 5, further comprising an accelerometer in communication with the vibrator.

7. The apparatus of claim 5, further comprising a pressurizable storage tank in communication with the feed tube, wherein the mixing chamber is configured to receive media when pressure within the storage tank is about equal to the pressure within the mixing chamber.

8. A system comprising:
a pressurizable media storage tank for storing media;
a pressurizable feed tube in communication with the tank;
a pressurizable mixing chamber in communication with the feed tube;
a tank sensor to detect pressure within the storage tank; and
a mixing chamber sensor to detect pressure within the mixing chamber;
wherein the mixing chamber is configured to receive media when the pressure within the storage tank is about equal to the pressure within the mixing chamber.

9. The system of claim 8, wherein the mixing chamber is configure to receive media via a two-part valve that opens to permit media to flow into the mixing chamber.

10. The system of claim 8, wherein the storage tank has a conic bottom, and further comprising a media plug disposed about the conic bottom.

11. The system of claim 8, further comprising a vibrator mounted external to the feed tube.

12. The system of claim 11, wherein the vibrator is configured to vibrate media received in the feed tube from the media tank substantially along the feed tube toward the mixing chamber.

13. The system of claim 8, further comprising a vibrator to vibrate the feed tube, and an accelerometer in communication with the vibrator.

14. An apparatus comprising:
a media feed tube having a feed tube discharge port;
a valve assembly in communication with the feed tube; and
a mixing chamber in communication with the feed tube, wherein the mixing chamber has a mixing chamber discharge port;
wherein the valve assembly comprises:
a housing;
a cup slideably disposed within the housing to close the feed tube discharge port; and
a ball flotably disposed within the housing to close the mixing chamber discharge port.

15. The apparatus of claim 14, wherein the mixing chamber has a conic bottom configured to receive the ball.

16. The apparatus of claim 14, further comprising a piston slideably disposed within the housing, wherein the ball is configured to ride the piston.

17. The apparatus of claim 14, further comprising a pressurizable media storage tank for storing media, and wherein the cup is slideably disposed to open the feed tube discharge port when pressure within the media storage tank and mixing chamber are about equalized.

18. The apparatus of claim 14, further comprising a non-pressurized vibrator mounted external to the feed tube.

19. The apparatus of claim 18, further comprising an accelerometer in communication with the vibrator.
